(19) United States
(12) Patent Application Publication
(10) Pub. No.: US 2012/0030970 A1
(43) Pub. Date: Feb. 9, 2012

(54) MAGNET VIBRATION DEVICE USING EXTERNAL PRESSURE AND SHOE HAVING THE SAME

(76) Inventor: Sang Gu KIM, Busan (KR)

(21) Appl. No.: 13/279,582

(22) Filed: Oct. 24, 2011

Related U.S. Application Data
(63) Continuation of application No. PCT/KR2010/002914, filed on May 7, 2010.

(30) Foreign Application Priority Data
May 8, 2009 (KR) 10-2009-0040167
May 8, 2009 (KR) 10-2009-0040170

(51) Int. Cl. A43B 13/14; H01F 7/02

(52) U.S. Cl. 36/25 R; 335/306

(57) ABSTRACT

Disclosed therein is a magnet vibration device, which is simple in structure, has little chance for breakdowns, and is applicable to various fields using vibration. The magnet vibration device includes: a case (100) that is changeable in shape by external pressure and has a restoring force when the shape of the case (100) is changed; a vibration plate (220) disposed inside the case (100) and changed in position in connection with the changed shape of the case (100); a first magnet (230) mounted on the vibration plate (220); and a second magnet (240) mounted at a position where a repulsive fore is generated between the first magnet (230) and the second magnet (240) when the position of the vibration plate (220) is changed.

### REFERENCE TO RELATED APPLICATIONS

This is a continuation of pending International Patent Application PCT/KR2010/002914 filed on May 7, 2010, which designates the United States and claims priority of Korean Patent Application No. 10-2009-0040167, filed May 8, 2009 and Korean Patent Application No. 10-2009-0040170, filed May 8, 2009, the entire contents of which are incorporated herein by reference.

### FIELD OF THE INVENTION

The present invention relates to a magnet vibration device using external pressure and a shoe having the same. More particularly, the present invention relates to a magnet vibration device using external pressure, which has a case with an elastic force and a restoring force and a vibration plate having a magnet and disposed inside the case in such a way as to generate vibration according to changes in the form of the case by external pressure.

### BACKGROUND OF THE INVENTION

Recently, as an interest in functional shoes increases, various kinds of shoes with vibration devices therein have been developed.

FIG. 1 illustrates an example of a shoe having a vibration device.

In FIG. 1, the vibration device includes a motor 20, a battery 40, and a switch 50 mounted inside the shoe for generating vibration.

When a wearer starts to walk after wearing the shoe, the switch is pressed by the wearer's weight, and then, electric current of the battery 40 flows to the motor 20. When the motor 20 works, an eccentric cam 22 mounted on a motor shaft rotates to generate vibration, and then, the vibration of the eccentric cam 22 is transferred to a vibration plate 30 mounted on the eccentric cam 22. Accordingly, the wearer can feel vibration from the sole of his or her foot like a foot massage effect.

However, such a shoe with the vibration function has several problems in that it requires a periodic exchange of the battery and in that it may not work normally due to a lot of breakdowns of the electric device. Moreover, the conventional shoe with the vibration function has further problems in that it is complicated in structure, and in that it is restricted to be applied to other fields due to a problem of volume.

So, new vibration devices, which are simple in structure, have little chance for breakdowns, and are applicable to other fields, are in desperate need.

### SUMMARY OF THE INVENTION

Accordingly, the present invention has been made in an effort to solve the above-mentioned problems occurring in the prior arts, and it is an object of the present invention to provide a magnet vibration device, which is simple in structure, has little chance for breakdowns, and is applicable to various fields using vibration.

Another object of the present invention is to provide a magnet vibration device, which is beneficial to a wearer's health by transferring vibration to the wearer's body and by transferring a change in magnetic force.

A further object of the present invention is to provide a shoe having the magnet vibration device.

To achieve the above objects, the present invention provides a magnet vibration device including: a case that is changeable in shape by external pressure and has a restoring force when the shape of the case is changed; a vibration plate disposed inside the case and changed in position in connection with the changed shape of the case; a first magnet mounted on the vibration plate; and a second magnet mounted at a position where a repulsive fore is generated between the first magnet and the second magnet when the position of the vibration plate is changed.

Preferably, the magnet vibration device further includes a guide member mounted inside the case, the guide member including a first lever and a second lever that change their relative distance when the case is changed in shape. The vibration plate is joined to one of the first lever and the second lever, and the second magnet is joined to the other one of the first lever and the second lever where the vibration plate is not joined.

Moreover, the magnet vibration device further includes a third magnet joined to the case in such a fashion as to generate a repulsive force between the first magnet and the third magnet when the vibration plate is changed in position. The first magnet is located between the second magnet and the third magnet.

Furthermore, the vibration plate is mounted on the wall surface of the case and is linked with the change in shape of the case.

Additionally, the magnet vibration device further includes stoppers adapted to limit a range of a change in shape of the case.

In addition, the magnet vibration device further includes an elastic member disposed inside the case to enhance a restoring force of the case when the case is changed in shape.

Moreover, the case has a coated layer formed on the whole outer face thereof.

In another aspect of the present invention, the present invention provides a shoe having the magnet vibration device mounted in the sole of the shoe in such a fashion that the case is changed in shape when a wearer walks.

Furthermore, the magnet vibration device is embedded in a space portion formed in the sole of the shoe and the space portion has a spare space for accepting the change in shape of the case.

The present invention has the following effects.

First, the magnet vibration device according to the present invention includes a vibration plate that is disposed inside a case with an elastic force and has a first magnet mounted thereon, and a second magnet (or a third magnet) that is disposed inside the case and generating a repulsive force together with the first magnet. Through the above configuration, when the case is changed in its shape by external pressure, vibration is generated due to a position change of the magnets. Accordingly, the present invention can simply realize the structure to generate vibration.

Second, the present invention can be used semipermanently because it does not require additional energy sources, and is applicable to various technical fields because of its compact size.

Third, because there is a change in magnetic force when vibration is generated and the change in magnetic force is transferred to the sole and skin of the wearer's food, the present invention is beneficial to a flow of blood.

### BRIEF DESCRIPTION OF THE DRAWINGS

FIG. 1 is an exploded view for explaining an example of a vibration device according to a prior art.

FIG. 2 is a sectional view of a magnet vibration device using external force according to a first preferred embodiment of the present invention.

FIG. 3 is an exploded perspective view of a vibration means according to the first preferred embodiment of the present invention.

FIG. 4 is a sectional view showing an operational state of the magnet vibration device using external force according to the first preferred embodiment of the present invention.

FIG. 5 is a sectional view of a magnet vibration device using external force according to a second preferred embodiment of the present invention.

FIG. 6 is a schematically sectional view showing a used state of the magnet vibration device using external pressure according to the second preferred embodiment of the present invention.

FIG. 7(a) is a sectional view of a first example of a case of the magnet vibration device according to the present invention, FIG. 7(b) is a sectional view of a second example of the case, FIG. 7(c) is a sectional view of a third example of the case, and FIG. 7(d) is a sectional view of a fourth example of the case.

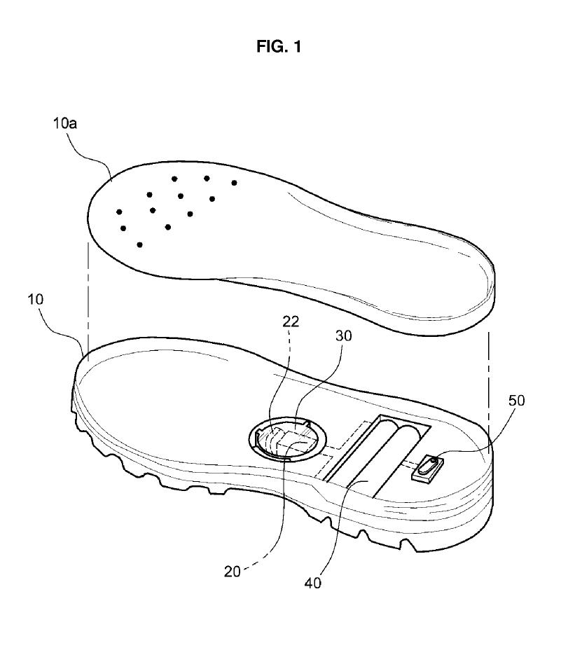

<Explanation of essential reference numerals in drawings>

| | |
|---|---|
| 100: case | 110: elastic member |
| 120: coated layer | 130: stopper |
| 141: upper member | 142: support member |
| 200: vibration means | 210: guide member |
| 212: first lever | 213: protrusion |
| 214: joining projection | 216: second lever |
| 218: joining groove | 220: vibration plate |
| 230: first magnet | 240: second magnet |
| 250: third magnet | 300: shoe |
| 310: space portion | |

### DETAILED DESCRIPTION OF THE INVENTION

Hereinafter, reference will be now made in detail to a magnet vibration device using external pressure according to the present invention with reference to the attached drawings.

The example embodiments described in this specification and the configurations illustrated in the drawings are just the most preferred embodiments of the present invention, and hence, they do not represent all technical ideas and scopes of the present invention. Accordingly, it should be understood that there is no intent to limit example embodiments of the invention to the particular forms disclosed, but on the contrary, example embodiments of the invention are to cover all modifications, equivalents, and alternatives falling within the scope of the invention.

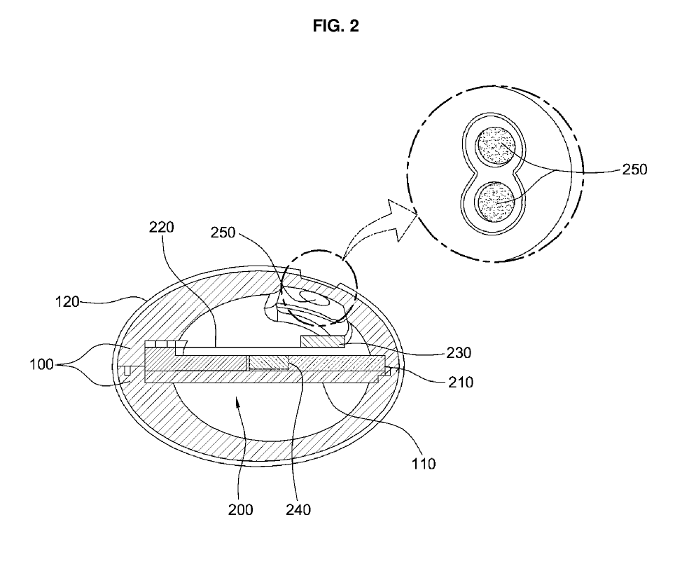

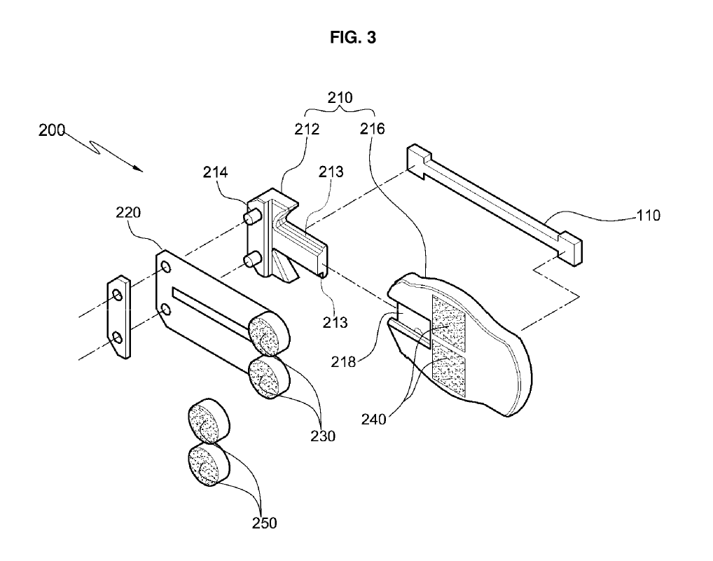

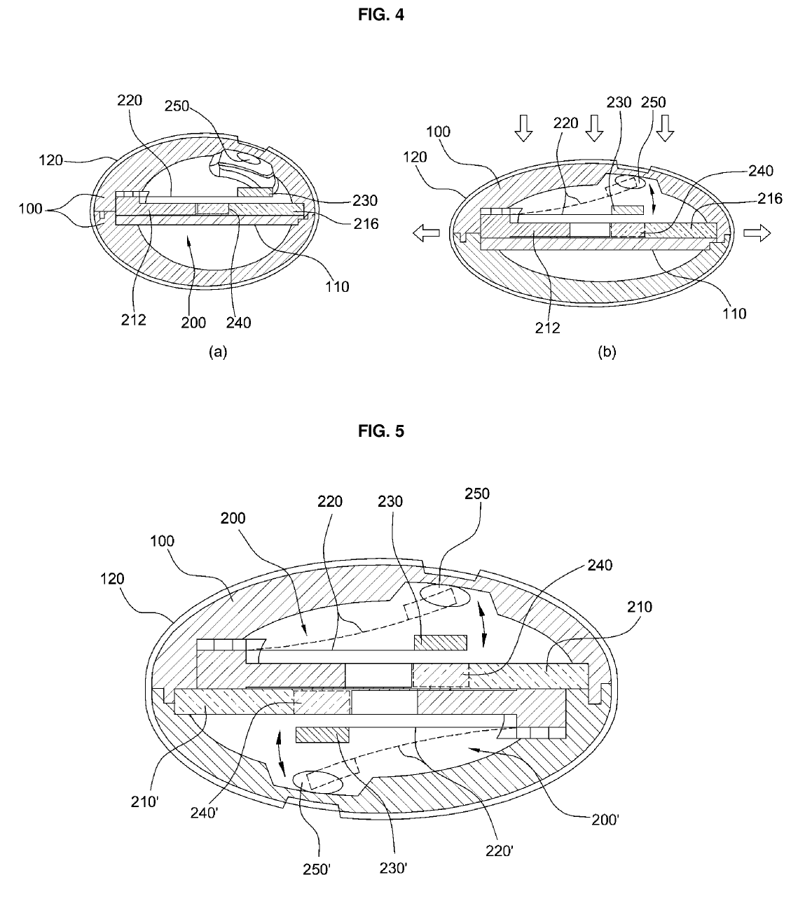

FIG. 2 is a sectional view of a magnet vibration device using external force according to a first preferred embodiment of the present invention, FIG. 3 is an exploded perspective view of a vibration means according to the first preferred embodiment, and FIG. 4 is a sectional view showing an operational state of the magnet vibration device using external force according to the first preferred embodiment.

First, referring to FIGS. 2 and 3, the magnet vibration device using external pressure according to the present invention includes a case 100 and a vibration means 200.

The case 100 is made of a soft material with elasticity so that it is compressed and be changed in shape when external force acts and is returned to its original state when the external pressure is removed. Moreover, it is preferable that the case 100 is divided into an upper part and a lower part for easy assembly and disassembly. Furthermore, the case 100 preferably has a coated layer 120 formed on the entire outer face thereof to provide solidity and sealability.

Additionally, the case 100 further includes an elastic member 110 disposed below the vibration means 200 inside the case 100 in order to enhance a restoring force when the case 100 is changed in shape by the external pressure.

In addition, the case 100 may be formed in one of various section shapes, such as an oval shape, a spherical shape, a hemispherical shape, and so on. Out of the above shapes, the oval shape illustrated in the drawings is the most preferable shape, and other shapes will be described in other embodiments.

The vibration means 200 is disposed inside the case 100 and is connected with the change in shape of the case 100.

As shown in FIG. 3, the vibration means 200 includes a guide member 210, a vibration plate 220, a first magnet 230, and a second magnet 240. Moreover, it is preferable that the vibration means 200 further includes a third magnet 250.

The guide member 210 is mounted inside the case 100 and includes a first lever 212 and a second lever 216 that provide a relative sliding by the change in shape of the case 100.

The first lever 212 has one side fixed to one side wall of the case 100, and includes protrusions 213 formed on both sides thereof and joining projections 214 formed for joining the vibration plate 220 to the first lever 212.

The second lever 216 has a joining groove 218 formed on one side thereof, which is joined with the protrusions 213 of the first lever 212. Accordingly, the portion of the first lever 212 where the protrusions are formed can be slidably joined to the second lever 216. Furthermore, the other side of the second lever 216 is fixed to the other side wall of the case 100.

Because the first and second levers 212 and 216 of the guide member 210 are respectively attached to the inner wall of the case 100, they are relatively slidable according to changes in shape of the case 100, and hence, there occurs a change in a relative distance between the first and second levers 212 and 216.

The first and second levers 212 and 216 should not be separated from each other during the sliding motion. That is, even though the case 100 is changed in the most compressed state by the external pressure, the first and second levers 212 and 216 must be designed to keep the joined state after sliding.

In the meantime, the vibration plate 220 is slidable together with the first and second levers 212 and 216 in a state where an end of one side of the vibration plate 220 is joined to the upper face of the first lever 212 or the second lever 216. Preferably, the vibration plate 220 is joined to the joining projection 214 formed on the upper face of the first lever 212 and is made of metals with elasticity.

Additionally, not shown in the drawings, but the vibration plate 220 may be directly mounted on the wall surface of the case 100 instead of the first and second levers 212 and 216. That is, the vibration plate 220 is located on an upper portion of the first lever 212, and in this instance, the end portion of the vibration plate 220 may be directly fixed not to the first lever 212 but to the wall surface of the case 100. Then, the vibration plate 220 can be moved in link with the changes in shape of the case 100, and it may produce a repulsive force between the second magnet 240 of the second lever 216, which will be described later, and the first magnet 230.

Meanwhile, the first magnet 230 is a general permanent magnet, which is disposed at an end of the other side of the vibration plate 220. Moreover, the second magnet 240 is also a permanent magnet and is disposed on one of the first and second levers 212 and 216 where the vibration plate 220 is not joined. That is, as shown in FIG. 3, the repulsive force is produced between the second magnet 240 and the lower surface of the first magnet 230 when the first lever 212 is moved in a state where the second magnet 240 is joined to the second lever 216.

Finally, the third magnet 250 produces the repulsive force together with the upper surface of the first magnet 230, and hence, the vibration plate 220 can be vibrated more smoothly inside the case 100. The third magnet 250 is joined to the upper face of the case 100 as shown in FIG. 2. In this instance, the portion of the case 100 where the third magnet 250 is joined may be thinner than other portions of the case 100. The reason is that it can produce a better vibration effect because the thinner portion may inherently produce vibration when the repulsive force is created between the third magnet 250 and the first magnet 230.

Now, an arrangement of the first, second and third magnets 230, 240 and 250 will be described. The first magnet 230 is disposed at the end of the vibration plate 220, the second magnet 240 is disposed on the second lever 216, which is disposed on a lower face of the vibration plate 220, and the third magnet 250 is aligned on the inner face of the case 100 in such a way as to be located on the upper face of the vibration plate 220. Accordingly, the first magnet 230 produces the repulsive force among the second and third magnets 240 and 250, which are respectively disposed on the upper face and the lower face of the first magnet 230, when the case 100 is changed in its shape. If the first magnet 230 has the N pole at the lower face and the S pole at the upper face, the second magnet 240 must have the N pole at the upper face and the third magnet 240 must have the S pole at the lower face.

Referring to FIG. 4, the operation of the magnet vibration device according to the present invention will be described.

If the external pressure is not applied to the magnet vibration device of the present invention, as shown in FIG. 4(a), there is no relative sliding between the first lever 212 and the second lever 216, and hence, the first magnet 230 fixed to the vibration plate 220 is not vibrated.

Meanwhile, as shown in FIG. 4(b), when the external pressure is applied to the upper face or the lower face of the case 100, the case 100 is compressed and becomes flat. Then, the first and second levers 212 and 216 disposed inside the case 100 take a sliding motion in the opposite direction to each other. Accordingly, the first magnet 230 of the vibration plate 220, which is mounted on the first lever 212, and the second magnet 240, which is mounted on the second lever 216, get nearer to each other, and the repulsive force is produced between the first magnet 230 and the second magnet 240, and then, the end of the vibration plate 220 is upwardly bounced and goes up due to the repulsive force. As described above, the vibration plate 220 suddenly bounced up generates vibration for a predetermined period of time due to its elasticity.

In this embodiment, the third magnet 250 may be additionally mounted on the upper portion of the first magnet 230 inside the case 100. Accordingly, the vibration plate 220 produces stronger vibration while moving between the second and third magnets 240 and 250 because a repulsive force may be produced between the first magnet 230, which is bounced up, and the third magnet 250.

In this instance, because the portion of the case 100 where the third magnet 250 is disposed is thinner than other portions of the case 100, the thinner portion is vibrated when the repulsive force is created between the first magnet 230 and the third magnet 250. Hence, not only the vibration plate 220 but also the case 100 may provide vibration.

Meanwhile, if the external pressure applied to the case 100 is removed, the case 100 is restored to the initial state due to the restoring force of the case 100 and the elastic member 110. Additionally, the first and second levers 212 and 216 of the guide member 210 get nearer while sliding, and then, are joined with each other. Due to the sliding motion, the first magnet 230 of the vibration plate 220 mounted on the first lever 212 and the second magnet 240 of the second lever 216 are dislocated from each other, and thereby, the repulsive force is not produced anymore.

When the above action becomes repetitive, the vibration plate 220 continuously bounces, and hence, can continuously generate vibration.

FIG. 5 is a sectional view of a magnet vibration device using external force according to a second preferred embodiment of the present invention.

Referring to FIG. 5, the case 100 has two vibration means 200 and 200′ therein. That is, the vibration means 200 and 200′ are respectively arranged at the upper portion and the lower portion of the case 100 in such a fashion as to be symmetric to each other, so that vibration and a magnetic force are generated at the upper portion and the lower portion of the case when the case 100 is changed in its shape. Additional description in relation with the operation of the magnet vibration device having the above structure will be omitted because it can be understood from the operation of the vibration means 200 in the first preferred embodiment, which is previously described.

Next, an example where the magnet vibration device described above is applied will be described.

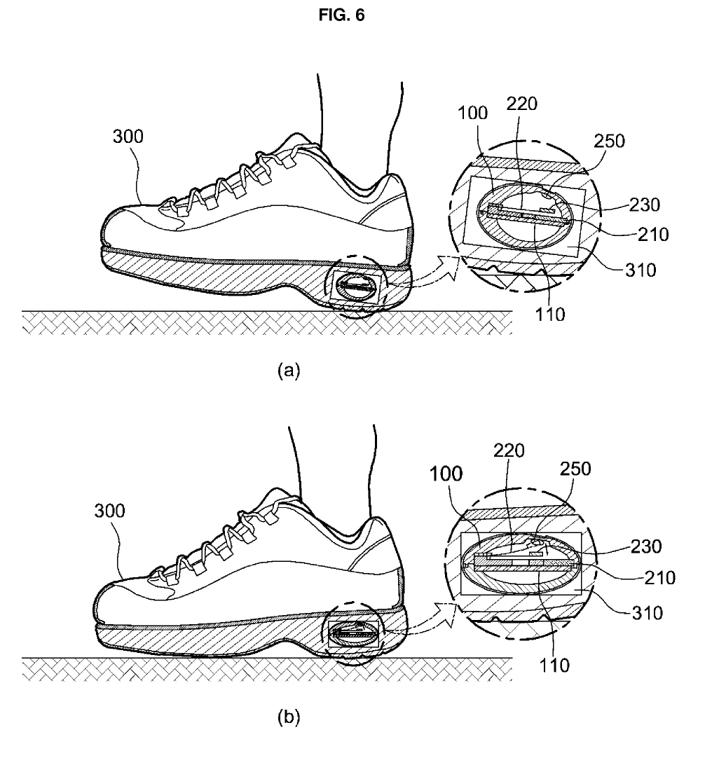

FIG. 6(a) and (b) are schematically sectional views showing a state where the magnet vibration device using external pressure according to the second preferred embodiment of the present invention is applied to a shoe.

Referring to FIG. 6, the magnet vibration device of the present invention is embedded in the heel portion of the sole of the shoe 300. Of course, the heel portion of the sole of the shoe 300 has a space portion 310 to mount the magnet vibration device therein, and in this instance, a spare space for accepting the change in shape of the case 100 must be secured.

As illustrated in FIG. 6(b), when a wearer starts to walk in a state where the magnet vibration device is embedded in the heel portion of the sole of the shoe 300, the case 100 is changed in its shape by the external pressure generated while the wearer walks. With the change in shape of the case 100, when the guide member 210 slidably moves, the first magnet 230 of the vibration plate 220 produces among the second and third magnets 240 and 250, and hence, the vibration plate 220 is vibrated.

Accordingly, the wearer can feel vibration of the vibration plate 220, and hence, can take exercises without boredom because the vibration makes interest in walking or running higher. Furthermore, the first magnet 230 of the vibration plate 220 creates a change in a magnetic field during vibration, and it may promote blood circulation on the sole of the wearer's foot.

Here, FIG. 6 illustrates an example where the magnet vibration device of the present invention is applied to the shoe for your better understanding, but the magnet vibration device of the present invention can be applied to various fields. That is, not shown in the drawings, but the magnet vibration device may be applied to a belt in such a fashion that it can generate vibration as the case 100 expands ambilaterally when the belt is expanded. Moreover, the magnet vibration device may be also applied to a dynamometer in such a fashion that vibration and the magnetic force are simultaneously transferred to the user's palm by the grasping strength.

In addition, the magnet vibration device may be also applied to a device to measure depth of water by measuring vibration generated when the shape is changed by water pressure.

As described above, the magnet vibration device of the present invention is applicable to various kinds of health care devices and can be widely used in various and different industrial fields.

Next, various examples of the case 100, which is changed in shape, will be described.

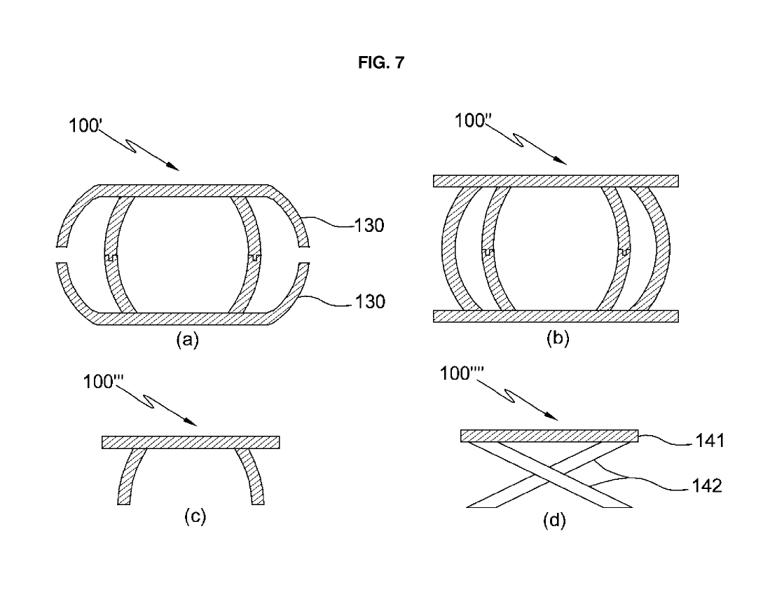

mom FIG. 7(a) is a sectional view of a second example of a case of the magnet vibration device according to the present invention, FIG. 7(b) is a sectional view of a third example of the case, FIG. 7(c) is a sectional view of a fourth example of the case, and FIG. 7(d) is a sectional view of a fifth example of the case.

First, it should be understood that the case 100 of the present invention any shape of the case 100 that is changed in shape by the external pressure and restored to its original form can be used, and FIG. 7 illustrates examples of several shapes of the case for your better understanding.

Referring to FIG. 7(a), a case 100′ according to the second example of the present invention has horizontal or nearly circular upper and lower sides. Moreover, the case 100′ has stoppers 130 disposed at upper and lower portions of both sides thereof to restrict a change range of the shape of the case compressed when the case is compressed by the external pressure. The case 100′ having the above shape includes the vibration means 200 as described above, and the vibration means 200 generates vibration according to the case 100′ changed in shape by the external pressure.

In the meantime, because the case 100′ that has the stoppers 130 can be prevented from being completely compressed by the external pressure, it can reduce a period of time for restoring to its original shape, and hence, it provides convenience in use.

Referring to FIG. 7(b), a case 100″ according to the third example of the present invention has a shape similar to the case 100′ of FIG. 7(a) but has double partition walls. The reason is to enhance elasticity of the case that is made of a soft material. Referring to FIG. 7(c), a case 100′″ according to the fourth example of the present invention has a hemispherical shape. The vibration means 200 is disposed below the hemispherical case 100′″ to thereby generate vibration when the shape of the case is changed.

Finally, referring to FIG. 7(d), a case 100′″ according to the fifth example of the present invention includes an upper member 141 and support members 142 disposed below the upper member 141 in an X-shape. The vibration means 200 is mounted below the support members 142, and when the external pressure is applied to the case, vibration is generated by the guide member 210 widened ambilaterally.

As described above, in the present invention, any of the case 100 that is changeable in shape by the external pressure without regard to the shape can be used.

While the invention has been described with reference to particular matters, limited embodiments and drawings, it will be understood by those skilled in the art that the invention is not limited to the particular embodiments disclosed since the embodiments are disclosed in the present invention for better understanding of the present invention, but various changes may be made and equivalents may be substituted without departing from the scope of the invention.

Because the present invention is a device to generate vibration when the external pressure is applied, the wearer can feel vibration when he or she wears body-contact goods in which the vibration device is mounted. Accordingly, because the wearer can enjoy repeated physical activities and feel the action of the external pressure, the vibration device according to the present invention can be usefully utilized in various industrial fields, such as shoes, belts, and so on.

What is claimed is:

1. A magnet vibration device comprising:
a case that is changeable in shape by external pressure and has a restoring force when the shape of the case is changed;
a vibration plate disposed inside the case and changed in position in connection with the changed shape of the case;
a first magnet mounted on the vibration plate; and
a second magnet mounted at a position where a repulsive fore is generated between the first magnet and the second magnet when the position of the vibration plate is changed.

2. The magnet vibration device according to claim 1, further comprising:
a guide member mounted inside the case, the guide member including a first lever and a second lever that change their relative distance when the case is changed in shape,
wherein the vibration plate is joined to one of the first lever and the second lever, and
wherein the second magnet is joined to the other one of the first lever and the second lever where the vibration plate is not joined.

3. The magnet vibration device according to claim 1, further comprising:
a third magnet joined to the case in such a fashion as to generate a repulsive force between the first magnet and the third magnet when the vibration plate is changed in position,
wherein the first magnet is located between the second magnet and the third magnet.

4. The magnet vibration device according to claim 1, wherein the vibration plate is mounted on the wall surface of the case and is linked with the change in shape of the case.

5. The magnet vibration device according to claim 1, further comprising:
stoppers adapted to limit a range of a change in shape of the case.

6. The magnet vibration device according to claim 1, further comprising:
an elastic member disposed inside the case to enhance a restoring force of the case when the case is changed in shape.

7. The magnet vibration device according to claim 1, the case has a coated layer formed on the whole outer face thereof.

8. A shoe having the magnet vibration device according to claim 1 that is mounted in the sole of the shoe in such a fashion that the case is changed in shape when a wearer walks.

9. The shoe according to claim 8, wherein the magnet vibration device is embedded in a space portion formed in the sole of the shoe and the space portion has a spare space for accepting the change in shape of the case.
